(19) United States
(12) Patent Application Publication
(10) Pub. No.: US 2011/0074120 A1
(43) Pub. Date: Mar. 31, 2011

(54) Rotary centrifuge seal with a phenolic overmold component and method of manufacture

(76) Inventors: David Namey, JR., New Kensington, PA (US); Michael D. Cima, Churchill, PA (US)

(21) Appl. No.: 12/924,420

(22) Filed: Sep. 27, 2010

Related U.S. Application Data
(60) Provisional application No. 61/277,738, filed on Sep. 28, 2009.

(51) Int. Cl. F16J 15/10; B29C 45/14

(52) U.S. Cl. 277/650; 264/267

(57) ABSTRACT

A rotary centrifuge seal consisting of a silicone rubber ring-shaped diaphragm secured to a phenolic ring member is manufactured by inserting the preformed phenolic compound element into a mold cavity of an injection compression mold with precise fit. The phenolic element is then covered with an overmold cavity and silicone rubber is injected into the overmold cavity by runnerless injection techniques in contact with exposed bonding surfaces of the phenolic compound element and the silicone rubber molding components and the phenolic compound element are compressed together to form a strong molecular bond with the application of heat and without the required use of primers, adhesives, bonding agents or mechanical bonding. The phenolic compound element is shaped in the form of a ring having external and internal peripheral surfaces whereby the exposed bonding surfaces include these internal and external peripheral surfaces to provide a more secure bond.

### CROSS REFERENCE

This application claims the benefit of U.S. Provisional Application No. 61/277,738, filed Sep. 28, 2009, and entitled ROTARY CENTRIFUGE SEAL WITH A PHENOLIC OVERMOLD COMPONENT AND METHOD OF MANUFACTURE, the content of which is incorporated herein in its entirety.

### BACKGROUND OF THE INVENTION

The present invention relates to seals for a rotary centrifuge bowl used for blood processing such as illustrated in U.S. Pat. Nos. 4,300,717; 5,045,048 and 5,882,289.

The seal incorporates a static seal that is formed of a ring-shaped diaphragm of elastomeric material which is joined at its radially inward periphery to the outer periphery of a non-rotatable ring member which rests on top of a lower rotatable ceramic ring. The elastomer member is formed of silicone rubber and the non-rotatable ring member is normally molded of a phenolic containing graphite or Teflon™.

The silicone rubber ring-shaped diaphragm must be mechanically secured to the phenolic ring member. This requires the use of time consuming and expensive manual labor for assembly, and a common result is that the elastomeric diaphragm does not properly seat on the phenolic ring which causes the seal to leak. Failure of this seal connection can result in contamination of the blood being processed.

The carbon phenolic compound is generally a mineral and graphite filled phenolic molding compound developed for seal applications. It consists of a condensation resin of phenol and formaldehyde, with enough crosslinker to cure any novolac presence, where the crosslinker is a phenolic resol or especially where the crosslinker is hexanethylenetetramine, and from 10% to 70% carbon filler consisting of graphite or amorphous carbon or any mixture of the two, and from 0% to 50% other additives and fillers commonly used in industry, such as waxes, pigments, and minerals, including, but not limited to, clay, talc, hydrated alumina, and calcium carbonates, and organic fibers, including, but not limited to, wood, cotton, and processed cellulose, and mineral fibers, including, but not limited to, glass, processed mineral fiber, and ceramic fiber. The premolded carbon phenolic member is compression molded.

The thermoset carbon phenolic materials are considered to be inert in that once molded under the conditions of high compression and high heat, it cannot be ground and remolded. They are not affected by heat or cold and they are highly resistant to petrochemicals, acids, bases, and ultraviolet light.

The premolded silicone membrane is injection molded and is slippery, smooth and nonbonding and considered to be inert in that once molded it cannot be ground and remolded. The nonbonding factor is considered to be a favorable attribute in many applications. Previous to the present invention, in order to achieve a bond with a nonbonding injection moldable silicone, a bonding agent had to be added to the silicone, therefore increasing the cost of the material. Also, in order to bond one part to another part produced from nonbonding injection moldable silicone to a substrate, a secondary adhesive, primer or mechanical bond (inter-engaging protrusions) has to be incorporated into the process. In the current seals, the molded silicone membrane is attached by hand assembly to the compression molded carbon phenolic using the compressive, elastic properties of the silicone rubber to provide a mechanical seal. As previously explained, a secondary process is required to impose the molded silicone rubber or molded silicone part onto the carbon phenolic.

### SUMMARY OF THE INVENTION

The present inventors have discovered an effective method of overmolding the silicone rubber membrane securely onto the carbon phenolic ring utilizing injection compression molding techniques.

The industry has and is of the opinion that the silicone rubber diaphragm and phenolic ring member must be mechanically joined as both components, the silicone rubber and the phenolic, are thermoset resins and have only been adequately joined with the use of primers, adhesive, bonding agents or mechanical means, as overmolding of the carbon phenolic has been perceived to be not possible due to the nature of the thermoset resins. Silicone by its very nature is very slippery and elements do not adhere to it. However, contrary to the beliefs in the industry, the present inventors have discovered and invented a method for overmolding the silicone rubber membrane on to the carbon or graphic phenolic ring member with a strong static bond that provides a seal which prevents the migration of liquids and the passage of air between the molded phenolic and the silicone, even though the two materials are dissimilar thermoset resins.

The design of the premolded phenolic features are critical, due to the brittle nature of the material. The phenolic part or element must withstand the clamp tonnage of the mold press and the mold without breaking, and also seal tightly to the mold cavity to prevent the silicone leaking around the premolded phenolic insert under injection pressures. The carbon phenolic premold is thus inserted into the injection compression mold with a precise fit, the mold is then partially closed and the silicone is then injected by runnerless injection techniques directly into the mold cavity, and the mold cavity is then completely closed to provide compression overmolding of silicone to the phenolic part with the application of heat (typically 450° F., more or less, which is a typical heat range utilized when overmolding products).

The strength of the bond between the carbon phenolic and the nonbinding injection molded silicone is such that a sharp implement or enough force to tear the silicone is required to break the bond. No hand assembly or secondary process such as application of primers, adhesives, bonding agents or mechanical bonding is required to apply the silicone to the phenolic part, thus providing unexpected results which solve or fill a long felt need in the industry, whereby overmolding silicone to graphite phenolic is provided while maintaining a molecular bonding of the two materials without using adhesives or primers. As previously mentioned, the design, form and mold dimensions of the phenolic part and a precise fit in the mold of the phenolic part are critical to the process as the premolded or preformed phenolic part is fragile and will otherwise break in the molding process.

The silicone features are designed to allow stripping the overmolded phenolic and silicone overmolded parts from the steel core of the mold without damage, while maintaining the critical seals in the molding operation.

The phenolic compound element is shaped in the form of a ring having external and internal peripheral surfaces, whereby during the injection compression molding process, the silicone rubber membrane is bonded to both the internal and external peripheral surfaces of the phenolic element for more secure bonding.

### BRIEF DESCRIPTION OF THE DRAWINGS

Other objects and advantages appear hereinafter in the following description and appended claims. The accompanying drawings show, for the purpose of exemplification, without limiting the scope of the invention or the appended claims, certain practical embodiments of the present invention wherein:

FIG. 1 is a top perspective view of the rotary centrifuge seal of the present invention;

FIG. 2 is a top view of the seal shown in FIG. 1;

FIG. 3 is a view in front elevation of the seal shown in FIG. 1;

FIG. 4 is a bottom perspective view of the seal shown in FIG. 1; and

FIG. 5 is a view in vertical mid cross section of the seal of the present invention as seen along section line V-V of FIG. 2 as received within a mold for illustrating the injection compression molding method of the present invention.

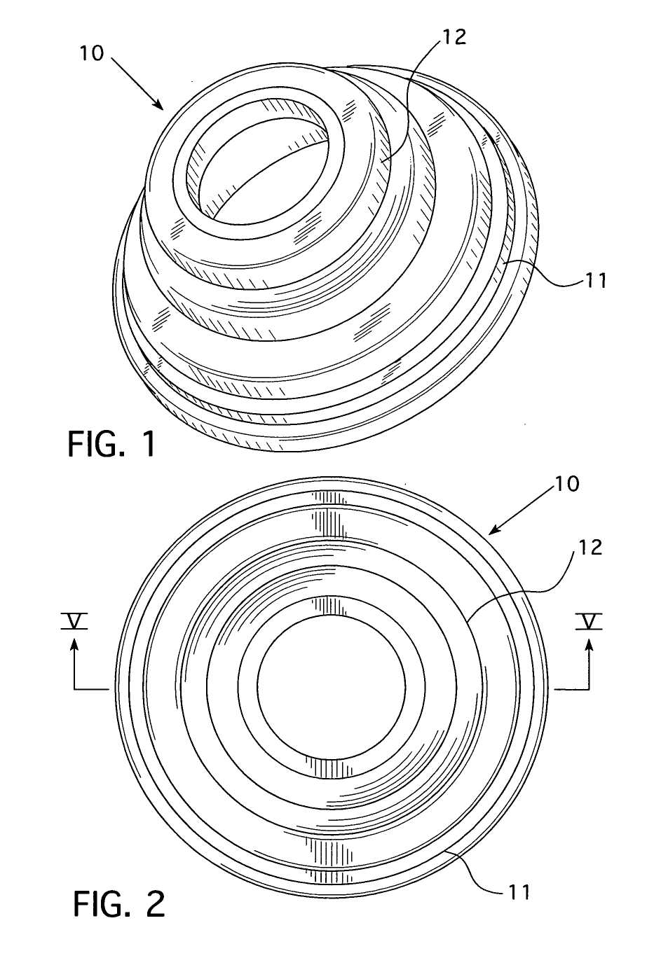

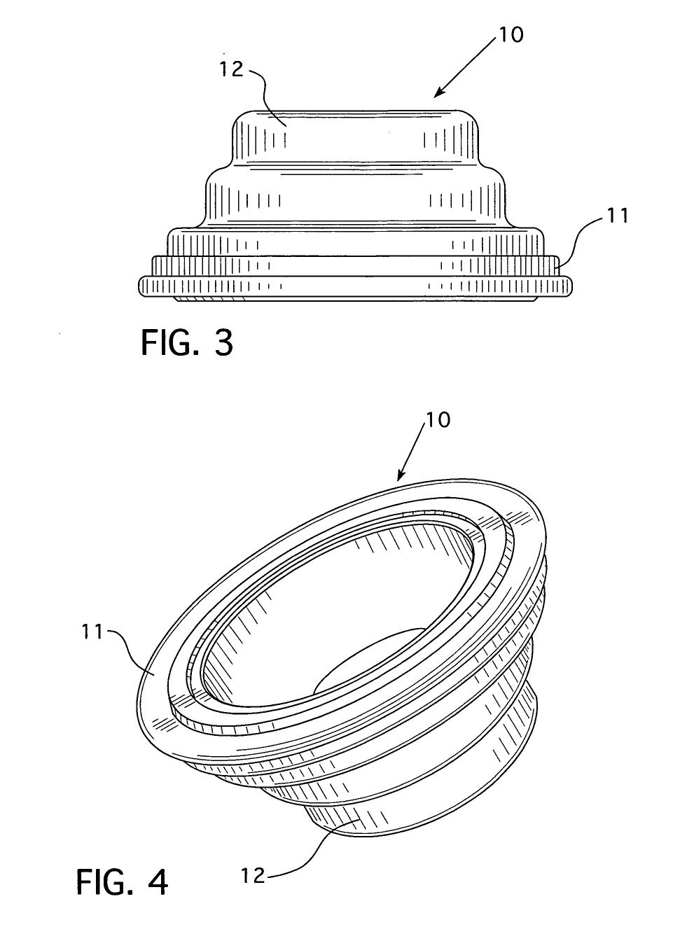

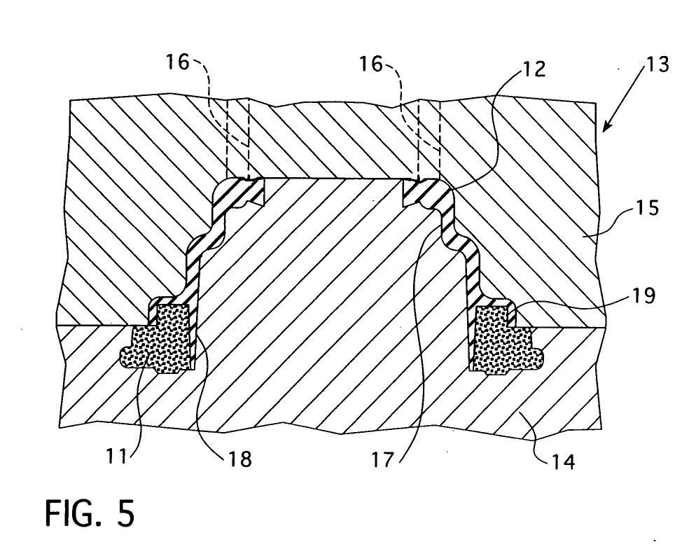

### DETAILED DESCRIPTION OF A PREFERRED EMBODIMENT

Referring to the drawings, the rotary centrifuge seal 10 of the present invention is comprised of a preformed annular phenolic compound element 11 which is molecularly bonded to a pliable silicone rubber membrane 12 by injection compression molding as illustrated in FIG. 5 without the use of primers, adhesives, bonding agents or mechanical bonding.

The preform phenolic compound element 11 is typically a carbon phenolic compound, generally a mineral and graphite filled phenolic molding compound developed for seal applications. It consists of a condensation resin of phenol and formaldehyde, with enough crosslinker to cure any novolac present, where the crosslinker is a phenolic resol or especially where the crosslinker is hexamethylenetetramine, from 10% to 70% carbon filler consisting of graphite or amorphous carbon or any mixture of the two, and from 0% to 50% other additives and fillers commonly used in the industry, such as waxes, pigments and minerals, including, but not limited to, clay, talc, hydrated alumina, and calcium carbonate, and organic fibers, including, but not limited to, wood, cotton and processed cellulose, and mineral fibers, including, but not limited to, glass, processed mineral fiber, and ceramic fiber. This premolded carbon phenolic member is compression molded.

As is partially illustrated in FIG. 5, the phenolic element 11 is inserted into injection compression mold 13, including base mold member 14 and upper mold member 15, with a precise fit, which is necessary as the phenolic part is extremely brittle in nature and must withstand the clamp tonnage of the mold press and the mold 13 itself without breaking and also seal tightly to the mold cavity to prevent the silicone leaking around the premolded phenolic element 11 under injection pressure. Once phenolic element 11 has been inserted into the mold bottom 14 with precise fit, the mold is then partially closed and the silicone 12 is injected through injection ports 16 by runnerless injection techniques directly into the mold cavity 17, and the mold cavity is then completely closed as illustrated in FIG. 5 to provide compression overmolding of the silicone 12 to the phenolic element 11 with the application of heat. The applied heat is typically in the area of 450° F., more or less, as is generally practiced in the art of injection compression molding.

In order to provide a more secure bond between silicone 12 and the phenolic element 11, the phenolic compound element is shaped in the form of a ring having external and internal peripheral surfaces 18 and 19 respectively, whereby the silicone rubber membrane 12 is bonded to both of these internal and external peripheral surfaces 18 and 19.

We claim:

1. A seal component comprising:
a preformed phenolic compound element; and
a silicone rubber membrane secured to said element by injection compression molding whereby silicone is injected by runnerless injection techniques to overmold said phenolic compound element and said silicone rubber membrane is molecularly bonded to said phenolic compound element without the use of primers, adhesions, bonding agents or mechanical bonding.

2. The seal component of claim 1, said phenolic compound element is shaped in the form of a ring having external and internal peripheral surfaces, said silicone rubber membrane bonded to both of said internal and external peripheral surfaces.

3. A method of manufacturing a seal component, comprising:
inserting a preformed phenolic compound element into a mold cavity of an injection compression mold with a precise fit;
covering said cavity and element therein with an overmold cavity;
injecting silicone rubber molding components into said overmold cavity and in contact with exposed bonding surfaces of said phenolic compound element; and
compressing said silicone rubber molding components and said phenolic compound element together with the application of heat to moleculary bond them together without the use of primers, adhesives, bonding agents or mechanical bonding.

4. The method of claim 3, wherein said phenolic compound element is shaped in the form of a ring having external and internal peripheral surfaces, said exposed bonding surfaces including said peripheral surfaces.
